(19) United States
(12) Patent Application Publication
(10) Pub. No.: US 2003/0085108 A1
(43) Pub. Date: May 8, 2003

(54) Electrical safety outlet which can prevent electric shocks from accidental contacts

(76) Inventors: Yi-Te Chiang, Taipei City (TW); Yi-Huang Liang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,942

(22) Filed: Nov. 2, 2001

(51) Int. Cl. H01R 33/96

(52) U.S. Cl. 200/51.09

(57) ABSTRACT

An electrical safety outlet includes a safety switch for a standard three-prong electrical outlet. The switch is located directly between the neutral and voltage slots on the outlet. In its normal state, the switch is not depressed, shutting off all current to the electrical outlet. However, when an electrical plug is inserted into the outlet, the main body of the plug will depress the switch, allowing the flow of current to begin. The addition of the safety switch will considerably reduce the risk of accidental electrical shock, which is especially effective towards children.

### BACKGROUND OF INVENTION

1. Field of the Invention

The invention relates to electrical outlets, and more particularly to an improved safety feature to protect against accidental electrical shock.

2. Description of the Prior Art

Plugging in or unplugging an electrical device is a common, routine task. Because it is done so often, there is always a small chance of being electrically shocked. A typical electrical outlet uses two or three slots in which the prongs on a plug will be inserted. Both types have a neutral slot and a voltage slot. The three-slot type contains an additional ground slot. While an electrical plug is being inserted or removed, fingers coming in contact with the prongs could produce a potentially dangerous shock. Moreover, electrical outlets are usually near ground level where children can reach them. A child sticking an object in an electrical outlet could receive serious injury.

There have been safety features built into electrical outlets in the past to reduce or remove this risk of shock. In U.S. Pat. No. 6,111,210 to J. B. Allison, issued Aug. 29, 2000, an electrical safety outlet is introduced. Please refer to FIG. 1, which is a component diagram of Allison″s electrical outlet 22 and an engaging plug 10. In this diagram, a two-pronged plug 10 contains a neutral prong 12 and a voltage prong 14. The plug 10 is lined up above the electrical outlet 22 that houses a neutral slot 16 and a voltage slot 18. Contained within the neutral slot 16 is a safety switch 20. Since the plug 10 has not been inserted into the slots 16, 18, the safety switch 20 is in its open state. When the neutral prong 12 is inserted into the neutral slot 16, the safety switch 20 is closed, thus completing the electrical circuit and allowing electricity to flow.

The main advantage to Allison″s design is a person placing his fingers along the surface of the electrical outlet 22 would not be able to shock himself. However, it is still possible for a person to be shocked even with the use of this safety feature. It is possible that a child could insert an object such as a paperclip into the neutral slot 16 and depress the safety switch 20, thus closing the electric circuit and shocking himself. Therefore, there is still a need for a safer electrical outlet that minimizes the risk of electric shock, especially the risk to small children.

### SUMMARY OF INVENTION

It is therefore a primary objective of the present invention to provide an electrical safety outlet to solve the above mentioned problemAccording to the claimed invention, the electrical safety outlet comprises a housing, a neutral slot and a voltage slot formed on the housing, and a switch installed on the housing between the neutral and voltage slots. When inserting the neutral prong and the voltage prong into the neutral slot and voltage slot, respectively, the flat surface on the main body of the plug will depress the switch, causing the flow of current to the electrical outlet and consequently the plug.

It is an advantage of the present system that inserting an object into any slot in the electrical outlet will not start the flow of electrical current. The only way for current to flow is if the switch is fully depressed, flush with the surface of the outlet. However, the body of the plug could easily depress the switch when inserted into the electrical outlet.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a component diagram of a prior art electrical outlet and an engaging plug.

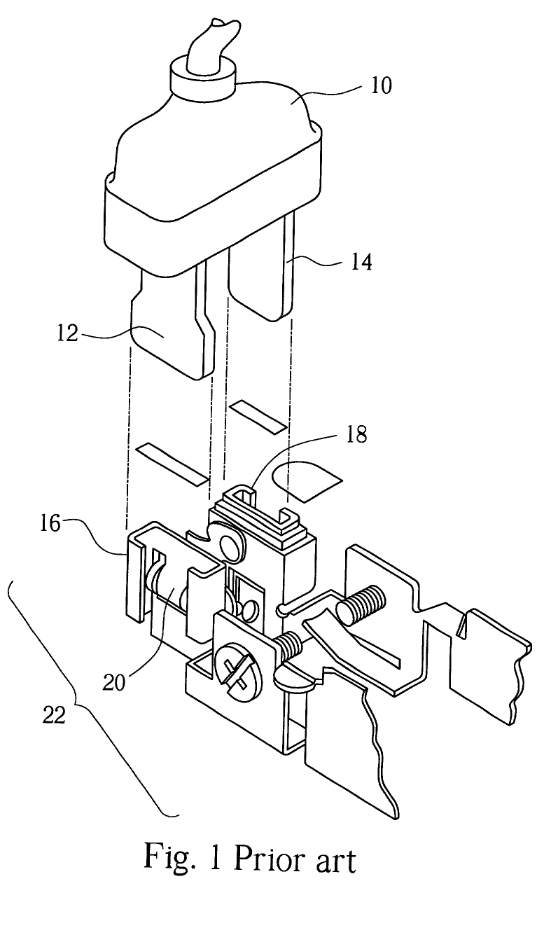

FIG. 2 is a perspective view of a three-prong electrical outlet and an engaging plug according to the present invention.

FIG. 3 is a top view of the electrical outlet in FIG. 2 showing the location of the safety switch relative to the three slots on the outlet.

FIG. 4 is an internal view of the electrical outlet in FIG. 2 showing how the switch appears before it is depressed, leaving the circuit open.

FIG. 5 is an internal view of the electrical outlet in FIG. 2 showing how the switch appears after it is depressed, closing the circuit to allow current flow.

### DETAILED DESCRIPTION

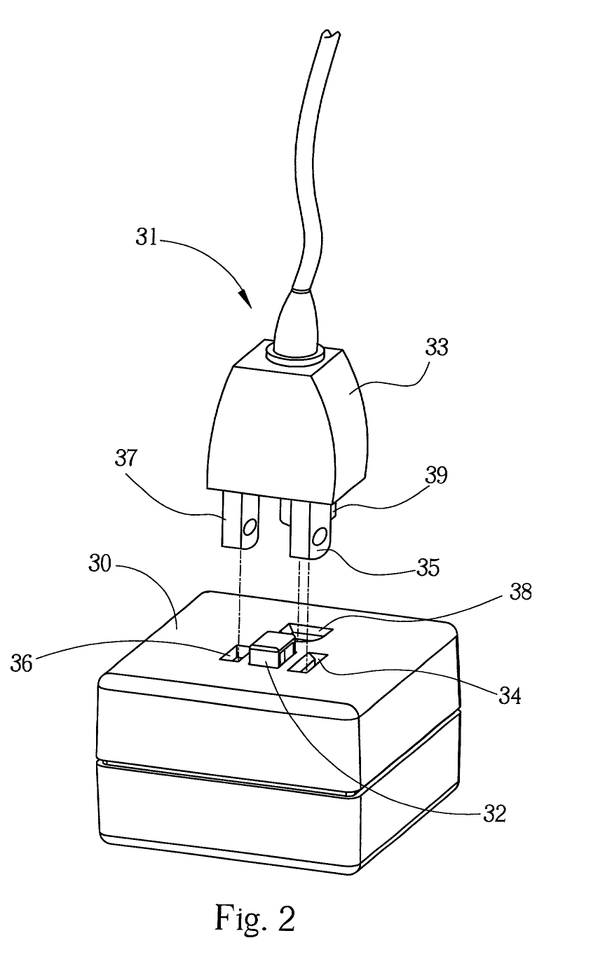

Please refer to FIG. 2. FIG. 2 is a perspective view of a three-prong electrical outlet 30 with an engaging plug 31 according to the present invention. This perspective allows the reader to see a switch 32 in its normal state. The plug 31 has a flat main body 33, a neutral prong 35, a voltage prong 37 and a ground prong 39. The flat body 33 of the plug 31 is made out of insulating materials to prevent shock. The switch 32 is located directly between a neutral slot 34 and a voltage slot 36. Located on the other side of the switch 32 is a ground slot 38.

When a plug 31 is inserted into the electrical outlet 30, the neutral prong 35, the voltage prong 37, and the ground prong 39 plug into the neutral slot 35, the voltage slot 36, and the ground slot 38 respectively. When the plug 31 is inserted into the electrical outlet 30, the flat main body 33 of the plug 31 will depress the switch 32. Because the switch 32 is located between the neutral slot 34 and the voltage slot 36, either a two-prong or three-prong plug 31 will depress the switch 32.

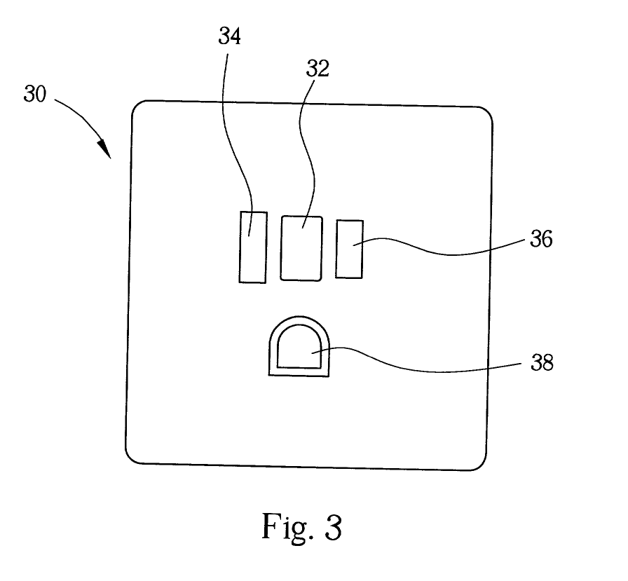

Please refer to FIG. 3. FIG. 3 is a top view of the electrical outlet 30 showing the location of the safety switch 32 relative to the neutral slot 34, the voltage slot 36, and the ground slot 38 all of FIG. 2. The reader will recognize this as a standard three-prong outlet with the safety switch 32 added.

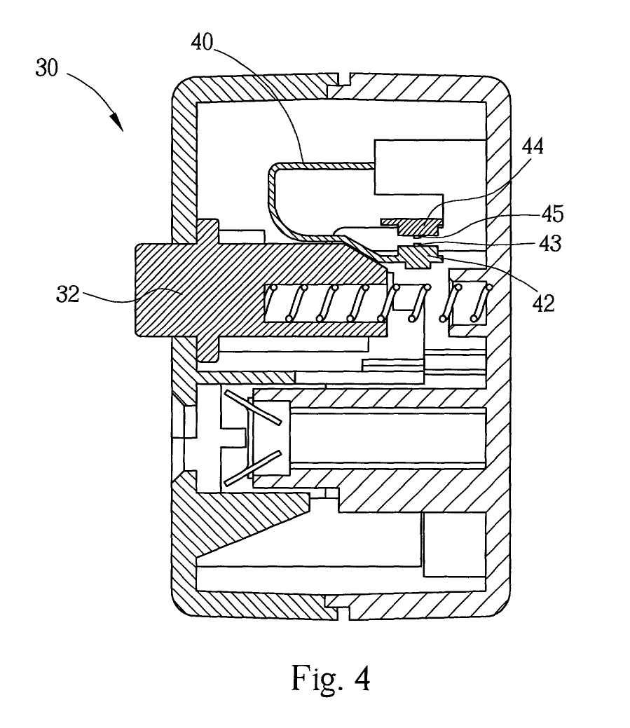

Please refer to FIG. 4. FIG. 4 is an internal view of the electrical outlet 30 showing how the switch 32 from FIG. 2 appears before it is depressed, leaving the circuit open. The switch 32 rests against an elastic conductive wire 40, which has an elastic contact 42 with a silver point 43 attached to the end of it. Located near the elastic contact 42 is a neutral contact 44 also with a silver point 45. Since this diagram is of the open circuit state, the elastic contact 42 is not making touching the neutral contact 44. This is the safe state of the electrical outlet 30 since the switch 32 has not been depressed.

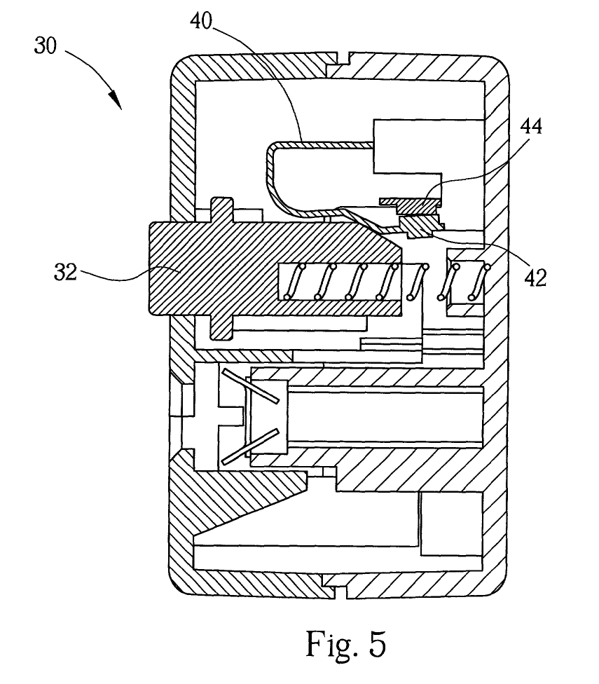

Please refer to FIG. 5. FIG. 5 is an internal view of the electrical outlet 30 in FIG. 2 showing how the switch 32 appears after it is depressed, closing the circuit to allow current flow. Notice that this time the switch 32 is pushed in, allowing it to push on the elastic wire 40 from FIG. 3. The elastic wire 40 then moves the elastic contact 42 from FIG. 3 so that it touches the neutral contact 44 from FIG. 3, and their respective silver points 43, 45 make electrical contact. Once the switch 32 is fully depressed, the switch 32 is activated and electrical current begins to flow. When the plug 31 is unplugged from the electrical outlet 30, the switch 32 will be restored, bringing the elastic contact 42 away from the neutral contact 44, causing their silver points 43, 45 to lose contact.

Compared with the prior art, the present invention will reduce the chances of accidental electric shock. The risk of being electrocuted while sticking an object into the neutral slot 34 has greatly been reduced. With the present invention, the added switch 32 provides a solid safety feature for guarding against electrocution. The switch 32 is also versatile as it can be used with a two-prong or three-prong switch.

Those skilled in the art will readily observe that numerous modifications and alterations of the electrical safety outlet may be made while retaining the teachings of the invention. Accordingly, the above disclosure should be construed as limited only by the metes and bounds of the appended claims.

What is claimed is:

1. An electrical safety outlet for receiving a plug, the plug comprising a main body, and a neutral prong and a voltage prong installed on the main body, the safety outlet comprising:
a housing;
a neutral slot and a voltage slot formed on the housing for receiving, in a mating direction, the neutral prong and the voltage prong, respectively, of a plug; and
a switch installed on the housing;
wherein when inserting the neutral prong and the voltage prong of the plug into the neutral slot and the voltage slot, respectively, of the outlet, the main body of the plug will depress the switch, causing the outlet to supply current to the plug.

2. The electrical safety outlet of claim 1 further comprising a neutral contact, an inner voltage contact and an elastic contact inside the housing, wherein after inserting the neutral prong and the voltage prong of the plug into the neutral slot and the voltage slot, respectively, of the outlet, the neutral prong will contact the neutral contact, the voltage prong will contact the inner voltage contact, and the plug will depress the switch to cause the elastic contact contacting the neutral contact so as to activate the outlet to supply current to the plug.

3. The electrical safety outlet of claim 2 wherein when unplugging the plug from the outlet, the switch will be restored bringing the elastic contact away from the neutral contact.

4. The electrical safety outlet of claim 2 further comprising a silver point at one end of the neutral contact, and a silver point at one end of the elastic contact, and when the switch is depressed, the silver point at one end of the elastic contact will contact the silver point at one end of the neutral contact to electrically connect the neutral contact with the elastic contact.

5. The electrical safety outlet of claim 4 wherein when unplugging the plug from the outlet, the switch will be restored bringing the silver point at one end of the elastic contact away from the silver point at one end of the neutral contact.

6. The electrical safety outlet of claim 1 wherein the main body of the plug is made of insulating materials.
